(19) United States
(12) Patent Application Publication
(10) Pub. No.: US 2001/0032163 A1
(43) Pub. Date: Oct. 18, 2001

(54) Method and apparatus for open market trading

(76) Inventors: Michael Fertik, Cambridge, MA (US); Raefer Gabriel, Cambrige, MA (US); Noah Lehmann-Haupt, Brookline, MA (US); William R. Wallis, San Francisco, CA (US)

Correspondence Address: Mary Lou Wakimura, Esq., HAMILTON, BROOK, SMITH & REYNOLDS, P.C., Two Militia Drive, Lexington, MA, 02421-4799, US

(21) Appl. No.: 09/729,635

(22) Filed: Dec. 4, 2000

Related U.S. Application Data
(60) Provisional application No. 60/169,182, filed on Dec. 6, 1999.
(60) Provisional application No. 60/169,183, filed on Dec. 6, 1999.
(60) Provisional application No. 60/203,774, filed on May 12, 2000.

(51) Int. Cl. G06F 17/60

(52) U.S. Cl. 705/37; 705/26

(57) ABSTRACT

Computer network apparatus for supporting open market trading is disclosed. The apparatus includes a) a database storing sellers' Asks and buyers' Bids, b) a means for receiving from a buyer or a seller an order to buy or sell a subject product, and c) filters for parsing sets of Bids and Asks stored in the database. A Commodity Filter parses based on user-specified attributes of products (Commodities). A Quantity Filter aggregates and filters the quantities of sets of the product. As such, customized screen views for the subject Class of product are displayed and enhance trading on the same. A match engine completes a transaction when an order is found to match a stored Bid or Ask. A participant enhancer notifies otherwise dormant buyers and sellers of the current displayed market and trading.

### RELATED APPLICATIONS

This application claims the benefit of U.S. Provisional Application Nos. 60/169,182 filed on Dec. 6, 1999; 60/169,183 filed on Dec. 6, 1999; and 60/203,774 filed on May 12, 2000.

The entire teachings of the above applications are incorporated herein by reference.

### BACKGROUND OF THE INVENTION

Applicants define the following terms:

Commodity—A product (including but not limited to physical goods, services, underlying financial instrument, or derivatives of other Commodities) that may be interchangeable with another product in its Class for certain buyers and sellers. A Commodity need not be a Perfect Commodity, and may have some set of attributes that describe it according to a Commodity Classification System.

Perfect Commodity—a product that is exactly interchangeable with all other products in its Class for all buyers and sellers. This type of product is often traded in traditional commodities markets.

Bid—an order to buy a Commodity or Commodities

Ask—an order to sell a Commodity or Commodities

Order—A Bid or an Ask

Class—type, kind, or classification (of a Commodity)

Trading Room—a virtual trading area or category for buying and selling a particular class of Commodity. This is the fundamental, or highest level, categorization of orders in the invention.

Marketplace—a virtual location, usually a web site or networked software product, that allows buyers and sellers to trade products as in sales transactions.

Symmetric Transaction Matching System—a technology of the present invention that continuously and automatically matches orders and executes transactions

Commodity Classification System—a technology of the present invention used to define and store user-specified attributes for a Commodity based on a set of pre-defined criteria

Commodity Filter—a technology of the present invention used to filter user-specified attributes for a Commodity based on a set of pre-defined criteria

Quantity Filter—a technology of the present invention used to aggregate and filter the quantities of sets of Commodities

Market Hunter—a technology of the present invention used to ensure that otherwise dormant market participants are alerted to the latest buying or selling opportunities.

### DESCRIPTION OF PRIOR ART

Online catalogs, such as those disclosed in U.S. Pat. Nos. 6,125,352 and 6,131,088, offer a massive improvement over traditional phone- and fax-based business; however, they require extensive searching and offer no dynamic pricing capabilities.

Online auctions, reverse-auctions, their variants, such as those disclosed in U.S. Pat. Nos. 5,890,138 and 5,794,219, offer dynamic pricing functions; however, they are not continuously clearing systems. That is, buyers and sellers must wait a specified period of time before a purchase can be finalized. In addition, bidders cannot place reliably effective Bids on a single item. That is, to insure that a Commodity is purchased or sold via auction a user must often place multiple Bids on multiple items, and may end up with all or none accepted at the end of the day. Finally, because specific items up for auction require specific Bids, the sale price may vary widely across like items depending on the distribution of the bidders.

Online Bid-Ask exchanges, in particular those under development by Ariba, VerticalNet, Intelligent/Digital, and @The moment attempt to solve many of the aforementioned problems relating to electronic marketplace inefficiencies in different ways. These companies provide continuously clearing Bid-Ask exchange systems; however, their systems work with Perfect Commodities and do not generalize, describe, and filter Commodities described by a multiplicity of attributes. In addition, these systems generally do not aggregate and filter quantities through an economics engine built with a thorough understanding of the functioning and needs of highly liquid markets. Thus these systems do not provide the automation or the efficiency of the present invention.

### SUMMARY OF THE INVENTION

Applicants' solution to the problem of electronic trading marketplace inefficiencies is an open-market model trading system for Commodities based on user-specified values of product attributes and non-product (contractual, delivery, and other marketplace-specific) attributes. The present invention builds on the traditional stock market model by extending the base trading functionally to allow for different Trading Room views to be dynamically generated for each user on the system, according to his specified economic desires and tradeoffs and for all internal order processing to occur through this same Commodity Filter system. Although several software providers advertise technologies that implement a similar open-market mechanism, only Applicants' solution has made the critical conceptual and technological advances necessary to offer the most efficient mechanism to buy and sell Commodities online.

In the present invention, a Marketplace exists as a series of “Bids” (orders to buy) and “Asks” (orders to sell) in a set of virtual trading areas (referred to herein as Trading Rooms) where the series of Bids and Asks may be filtered and viewed according to the attributes of the Commodity Classification System and the usage of these attributes in the Commodity Filter. This allows a Trading Room to contain a wide variety of different but related items, and the user to view a subset of that according to his preferences. Bids do not refer to a specific item for sale, but rather indicate interest in a Class of Commodity being traded. Any qualified seller may accept a Bid and instantly fill the corresponding order. Likewise, any buyer may accept an Ask and instantly purchase an item from the seller. In this economic model, buyers compete with one another for the highest-priced Bids, and sellers compete for the lowest-priced Asks. The invention utilizes one or more remote clients through which trades are made by users of the Marketplace, who enter Bids or Asks at the remote client. The entered Bids or Asks are processed by a server application (of the present invention) to compare the orders, find matching orders, and assist in the rapid completion of transactions in the Marketplace either by automatically executing orders or by presenting views of orders to the users to manually select for execution with their own orders.

The present invention's Commodity classification technology, coupled with its attribute and quantity filtering technologies (referred to as the “Commodity Classification System”, “Commodity Filter”, and “Quantity Filter”, respectively), facilitate the creation of the aforementioned user-specific Trading Room views. These technologies also facilitate the process of automated order matching and significantly increase market liquidity (the rate at which orders are matched in different trading models, given a constant demand and supply). All such automated matching is facilitated by the Symmetric Transaction Matching System (STMS). In this context, the Commodity Classification System and Commodity Filter allow multiple non-fungible items to be traded within an marketplace as fungible, or identical from the perspective of a given user or another Order, depending on the user's preference for certain Class specific criteria.

The Quantity Filter allows, through aggregation and filtering, a Trading Room view to be created for a specific number of items. Orders are instantly and transparently combined or reduced in quantity to ensure that only valid, equivalent comparisons of orders are being presented to the end user or are being used for internal matching in the STMS. In particular, the Quantity Filter enables the combination of Asks across different sellers to form an aggregate quantity and price of the subject product which fulfills a sum total of different buyers' orders. The Quantity Filter also enables combining of different Bids across different buyers to form a sum total quantity that matches selling quantity of a seller's order.

To further enhance market liquidity the present invention provides a Market Hunter module, which ensures that otherwise dormant market participants are alerted to buying or selling opportunities in an active marketplace.

The Bid-Ask open marketplace model of the present invention offers three clear advantages over auction-style marketplaces for the following reasons: 1) it allows immediate transactions (i.e., it does not require buyers and sellers to wait a specified period of time to complete transactions); 2) it empowers buyers and sellers to make reliably effective Bids and Asks (i.e., it does not require multiple Bids on a single item or multiple Bids on multiple items); and 3) it facilitates exchanges at the most optimally efficient prices.

Applicants' system builds on the advantages of the open-market marketplace model by extending the model to allow for preference based market matching, trading, and viewing by effectively generalizing, describing, and filtering Commodities as well as aggregating and filtering quantities through an economics engine designed specifically with highly liquid markets in mind. The present invention incorporates other significant details of market efficiency and includes technologies to allow trading according to a user's price/time tradeoff, to automatically aggregate supply and demand within a market, to automatically maintain a continuously clearing, highly liquid exchange, and to ensure all market participants are aware of the most pertinent buying or selling opportunities whenever possible.

Thus the present invention provides a computer method and apparatus for enhancing the purchase and sale of Commodities on the Internet. In the preferred embodiment, the invention apparatus includes:

a. a source of information providing

i. a plurality of Asks for certain products from different sellers;

ii. a plurality of Bids for a general product type from different buyers;

b. a means for receiving from a buyer or a seller an order to buy or sell a subject product, the product being of a subject Class; and

c. one or more filters coupled to the receiving means and the source of information, for parsing sets of Bids and Asks for a specific Class of products such that a customized screen view for the subject Class of product is displayed and enables desired trading on the same.

Preferably, the customized screen view is a Trading Room screen view displaying buyers' Bids and sellers' Asks for the subject Class of product, and the Trading Room screen view serves as the means for receiving Bids. Further, asking prices of a seller for a respective type of good includes different prices as a function of time and/or as a function of trading activity for the product class.

The preferred method for carrying out Commodity transactions according to the present invention includes the computer implemented steps of:

a. Providing a plurality of Asks for certain products from different sellers;

b. Providing a plurality of Bids for a general product type from different buyers;

c. Receiving from a buyer or a seller an order to buy or sell a subject order; and

d. any combination of combining Bids as a function of quantity and price to fulfill a seller's order; and combining Asks as a function of quantity and price to fulfill a buyer's order.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is an overview of a computer network (the Internet) in which the preferred embodiment of the present invention exists

FIG. 2 is a schematic overview of the present invention software system

FIG. 3 is a block diagram of the Commodity Filter employed in the software system of FIG. 2 to generate custom Trading Room views

FIG. 4 is a block diagram of the Commodity Filter matching orders in the software system of FIG. 2.

FIG. 5 is a block diagram of a Quantity Filter employed in the software system of FIG. 2.

FIGS. 6a- 6d are views that illustrate output from the Quantity Filter operating as in FIG. 2.

FIG. 7 is an illustration of an order creation screen view.

### DETAILED DESCRIPTION OF THE INVENTION

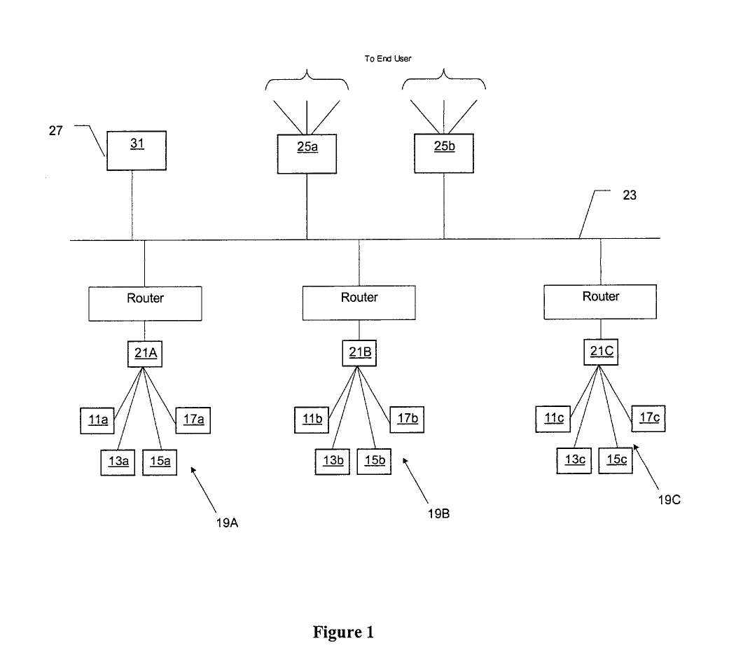

Illustrated in FIG. 1 is a plurality of networks 19a, 19b, 19c. Each network 19 includes a multiplicity of digital processors or 11, 13, 15, 17 (e.g. PCs, handhelds, etc.) loosely coupled to a host processor or server 21a, 21b, 21c for communication among the processors within that network 19. Also included in each network 19 are printers, facsimiles and the like. In turn, each host processor 21 is coupled to a communications line 23 which interconnects or links the networks 19a, 19b, 19cto each other to form a network of networks. That is, each of the networks 19 are themselves loosely coupled along a communications line 23. In the preferred embodiment, this network of networks is the Internet. Various servers 25a, 25b, which provide end users access to the Internet (i.e., access to potentially all other networks 19, and hence processors 11, 13, 15, 17 connected to the Internet), are also linked to communication line 23.

The preferred embodiment is a software program 31 operated on and connected through server 27 to the Internet for communication among the various networks 19 and/or processors 11, 13, 15, 17, and other end users connected through respective servers 25. Server 27, or a multiplicity of such servers, runs an Enterprise Java Bean container program, such as the BEA Weblogic Server or an equivalent product (as defined below), and utilizes HyperText Transfer Protocol (HTTP) to transmit the results which support the operation of the invention. The preferred embodiment employs the latest Java 2 Enterprise Edition (J2EE) architecture that uses Java Servlets, Java Server Pages, and Enterprise Java Beans (EJBs) in a three tiered configuration where the presentation tier (Servlets and Java Server Pages) communicate with the business logic tier, which is implemented using EJBs and independent Java components that communicate using the Java Messaging Service (JMS), an interface for enterprise messaging. This provides for a highly scalable, modular, layered approach to system design that allows for the best possible extensibility and fault tolerance. The invention system 31 offers a technology that allows for a variety of pluggable business logic components to make it flexible enough for a range of users with different business operation practices. Furthermore, the cross platform nature and object neutrality of the J2EE architecture allows for easy integration with a variety of related systems, including legacy enterprise and other peripheral market systems.

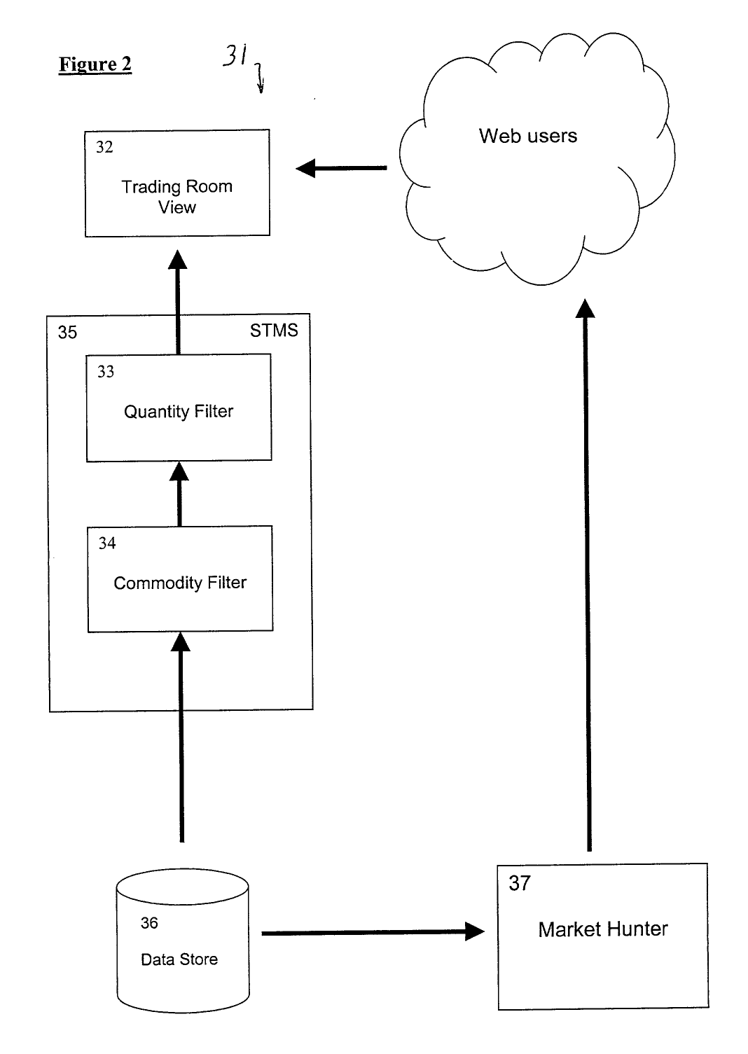

Illustrated in FIG. 2 is the overview of the invention's software system 31, providing the invention's Trading Rooms, filtering and matching capabilities. Order related information including but not limited to data used by the Commodity Classification System is stored in a portion of a database 36 along with user information (e.g. addresses and other such contact information) and other preferences.

In the preferred embodiment, the database 36 stores the sellers' and buyers' orders in respective records. For each record there are fields corresponding to the features, quantity, price and other such details of the order. With respect to sellers, the database 36 stores one record per commodities/items for sale by the seller. In a given record corresponding to certain commodities, there are respective fields for indicating quantity, color, other features, attributes and prices of the commodities. Price may be stated in a sliding scale as a function of quantity for volume discounts or as a function of time and buyer activity, and the like. Fields may be implemented in Boolean (e.g., one bit), integer, or real number values, text/character strings or other data types and structures (e.g., arrays, link strings, etc.) as appropriate. Commodity Classification System data is stored in multiple rows for each order. Each row contains the attribute name and all relevant attribute values, which are concatenated together and stored as a string. This represents a balance between rapid pattern matching, rapid loading and storing of order attribute information and the need for atomicity and concurrency of attribute data storage.

Each seller is assigned a unique ID within the system 31 for indicating Ask orders by that seller. A seller's orders indicate the inventory of goods that the seller is willing and able to sell. In a “soft Ask”, which is an indication of potential interest in selling some good, the good represented by the order may not be immediately available, or for some other reason, the seller is unwilling to commit to a fixed price on the open market. In the preferred embodiment, the seller's order indicates quantity, asking price and attributes from the Commodity Classification System of the Commodities. The invention system 31 formulates functional rules from these terms, including order expiration time and data rules for dynamic price changes. For example, a seller may indicate that the asking price may increase or decrease as a function of time and buyer activity. That is, after a relatively long period of time as predefined in the seller's order, if buyer activity is below a threshold, then the seller may indicate that the price is to decrease to the highest buyer's Bid. On the other hand, over a short amount of time, if buyer activity is above a certain threshold, then the seller's asking price is to be adjusted upward by a certain amount as indicated by the seller's order.

The formulated rules are stored with the seller's orders in database 36.

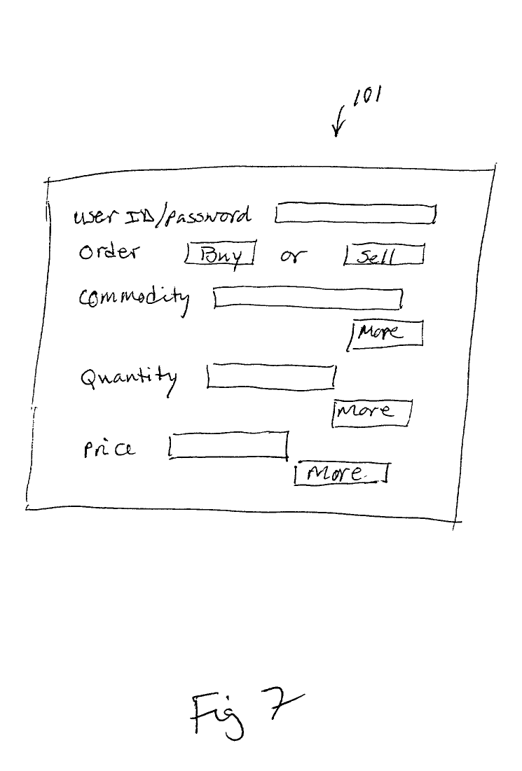

In the preferred embodiment, the user communicates preferences in one of two ways: the seller communicates his order properties in a fixed manner through an order creation screen view 101 as illustrated in FIG. 7. Single exact values are specified for attributes associated with the Commodity Filter 34, which describe an available product. Similarly, a buyer indicates his Bid orders through such an order creation screen view 101, specifying some set of desired attributes for a Bid. The alternative method is interactive viewing of the Trading Room screen 32 (FIG. 1), wherein the buyer or seller may view in real time a subset of the existing Bid and/or Ask orders in the Trading Room, by specifying in a control panel area the desired settings for the Commodity Filter 34 and Quantity Filters 33.

With respect to buyers, in a given record corresponding to certain desired Commodities, there are respective fields for indicating desired quantity, attributes and prices of the Commodities. The system assigns each buyer a unique ID and stores the buyer's Bid orders in the database 36, indicating the buyer by his ID. The buyer's Bid order indicates the specifications of the Commodity that the buyer desires to purchase. This is unlike online auctions in which the buyer is bidding on a specific individual item. In the buyer's order, the buyer indicates quantity, the features and attributes of the kinds of commodities desired and price that he is willing to pay. The buyer also states the terms at which he is willing to pay a higher Bid price such as with a larger quantity so that more economical price per unit is obtained or to increase his price as a function of time because the buyer wishes to complete the transaction by a certain ending date and time. From these buyer stated terms, the system generates rules that are stored in the database 36 along with buyer's orders.

In the preferred embodiment, the database 36 stores one primary record per Commodity desired by the buyer and one primary record per Commodity available from a seller. The detailed attribute information and Commodity Classification System information are stored in multiple records for each Commodity, one for each Commodity attribute—this is discussed in further detail below.

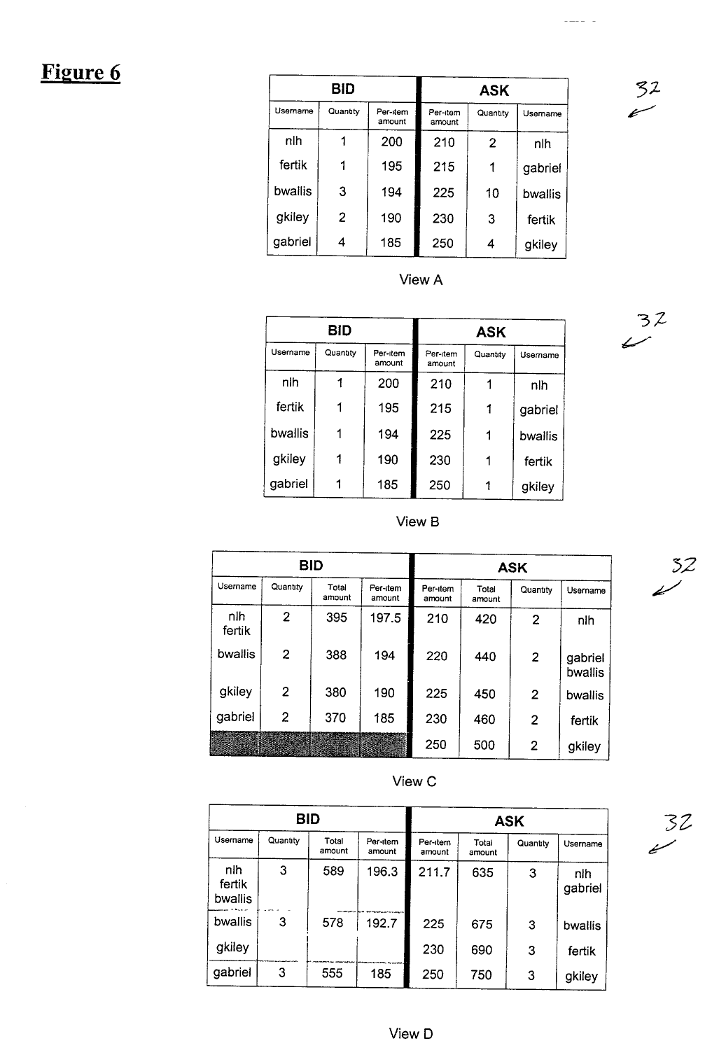

Returning to FIG. 2, the end user views a Trading Room screen 32 which shows for a certain kind of Commodity, the buyer's orders (Bids) and the seller's orders (Asks) of that kind of commodity as stored in the records of the database 36. Illustrations of various Trading Room screen views 32 are provided in FIGS. 6A-6D. It is through this screen 32 that the user views and inputs transactions. The screen is 32 updated by the supporting technologies, namely the Commodity and Quantity Filters 34, 33 and STMS 35.

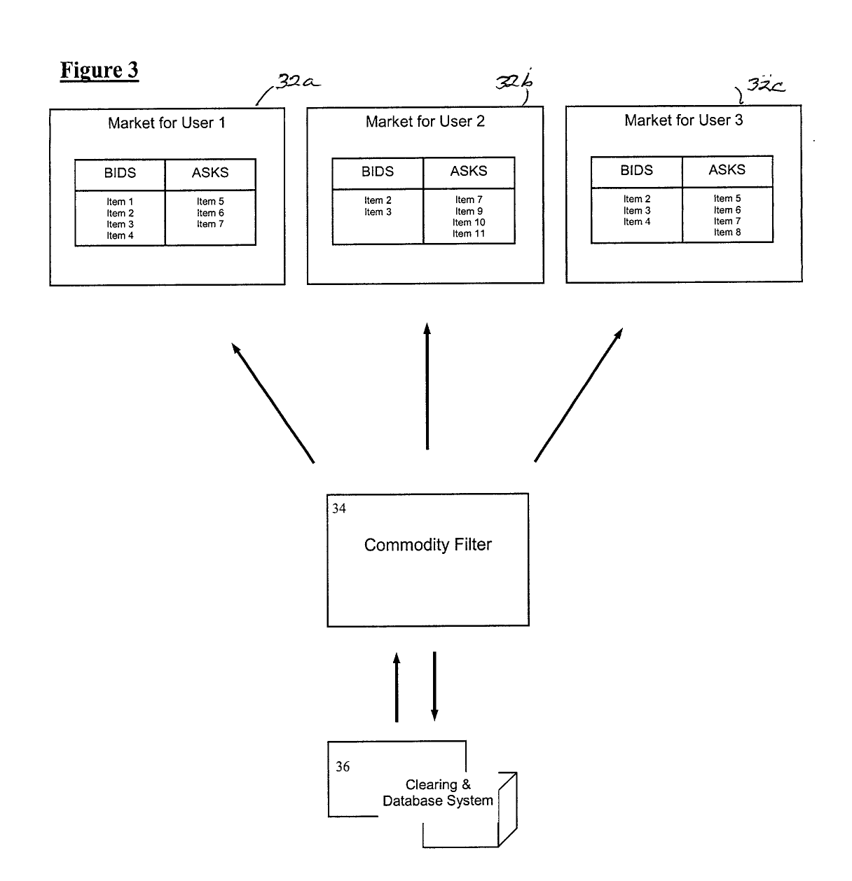

The Commodity Filter 34 is at the lowest level of the system 31 and parses users' preferences to generate a custom dynamic view of the Trading Room. This in effect allows end users to view non-identical items as completely interchangeable (i.e. imperfect Commodities behave as Perfect Commodities within the scope of a single view 32). As illustrated by FIG. 3, varying sets of items will appear in Trading Room views 32a, b, c for the same Class of Commodity based on user preference. Trading Rooms are defined only in broad categories (Classes) based on the least common denominator, so, for example, a steel Trading Room will be distinct from a copper Trading Room. The Commodity Filter 34 allows users to configure a custom market from both Commodity specific attributes and market specific attributes (e.g., delivery location, commitment date, shipment and payment terms, etc.). Users' preferences might only partially overlap with one another. Under existing trading models for the exchange of products, this situation would cause an inefficiency in the transaction as different users are either viewing an overly broad or overly narrow category of products or must search through many available orders or products.

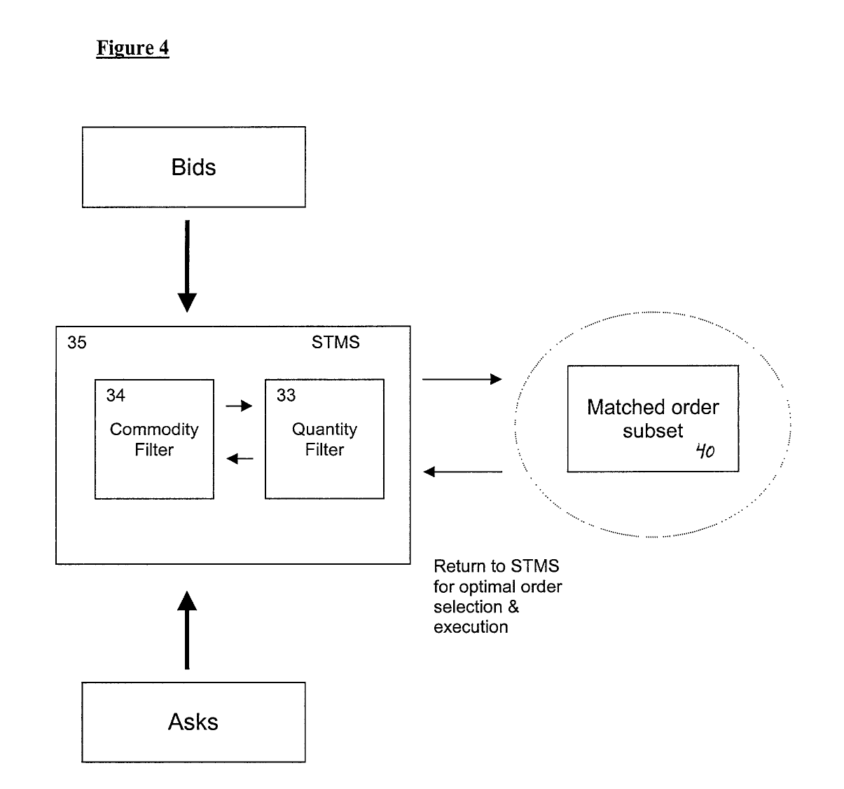

As illustrated in FIG. 4, the Commodity Filter 34 not only facilitates such custom Trading Rooms, but also enables the automated matching and execution of orders behind the scenes through the action of the STMS 35. The Commodity Filter 34 generates a subset 40 of matched Bids and Asks. The STMS 35 determines the most desirable matched orders in the subset 40 (based on price or a composite property on which a set of orders can be sorted) and then executes these for the user. The Commodity Filter 34 in this role is used to support the automatic, continuous matching processes of the Marketplace rather than being used as a filter for on-demand viewing.

In the preferred embodiment, the Commodity Filter 34 is written in Java with embedded SQL-92 (Structured Query Language) commands. The Commodity Filter 34 works by dynamically constructing a multi-attribute SQL (Structured Query Language) query that is used to select relevant information from the database 36, or as a filter for message traffic at any point in the system 31. This query is composed of a number of subclauses equal to the number of attribute values processed by the Commodity Filter 34 for the view parameters on which the Trading Room is being filtered. By utilizing multiple database rows per order, storing multiple attribute values in single columns, and using a standard string fingerprinting and matching algorithm for each attribute, performance is improved significantly over standard indexed relational storage, where each order corresponds with one name-value pair stored for each attribute value it possesses.

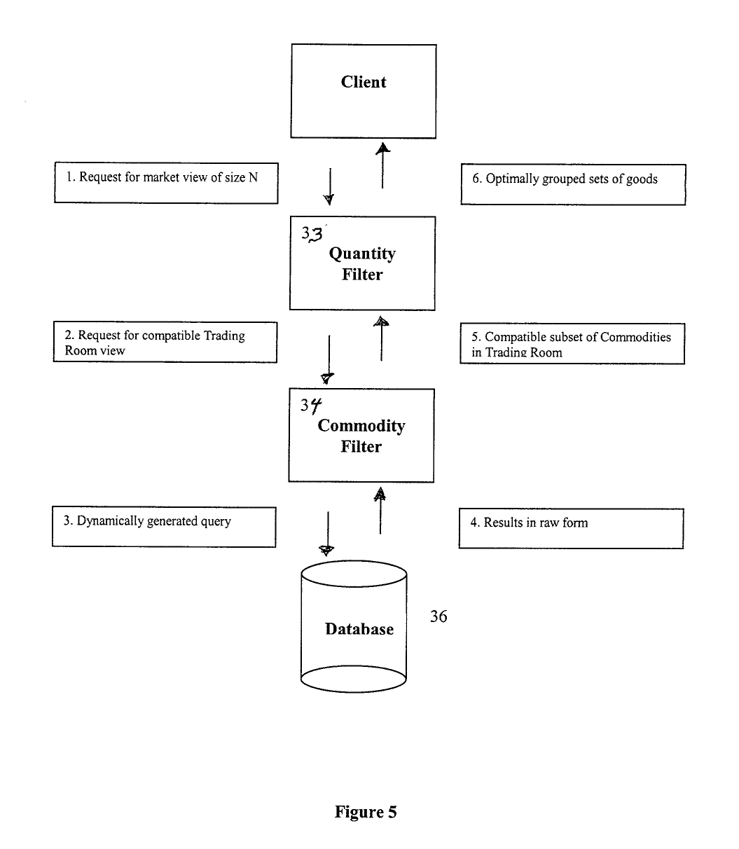

Once the view of the market is determined, the Quantity Filter 33 handles the number (quantity) of items in that market as illustrated in FIG. 5. Again, the invention 31 is designed to allow the end user at all times to view the optimal market, no matter how many or how few of a commodity that user wishes to trade. For example, a buyer of 10,000 lbs. of hot rolled steel might normally (in prior art systems) find that sellers are only offering lots of 2,000 lbs. However, the present invention system 31 provides the automatic aggregation of five such offers to create a custom virtual offer of 10,000 lbs. specifically for the buyer. Should the buyer accept the offer, the system 31 automatically clears and routes the five separate transactions seamlessly and quickly. On the other hand, if a wheat buyer is only interested in purchasing a small lot of 100 bushels, the invention system 31 displays offers of that size wherever possible. The Quantity Filter 33 also serves as an averaging mechanism and allows natural market forces to take effect quickly. As long as the total amount of a group of buyers' Bids equals the amount of one or more sellers' Asks (in aggregate), the system 31 clears the transaction.

As illustrated in FIG. 5, an end user (through the client portion of invention software 31) requests a market view of a particular size (step 1) for a particular Commodity (step 2). In response to the request, at step 3the Commodity Filter 34 generates appropriate queries (as discussed above) which the database system executes against database 36. Commodity Filter 34 receives the resulting data (Bids and Asks for the subject Commodity) from database 36 (step 4). According to end-user preferences (i.e., the end user's request), the Commodity Filter 34 generates (at step 5) a subset of the data (Bids and Asks) for display in a Trading Room view 32 as discussed above. The Quantity Filter 33 further groups sets of the Bids and/or Asks in the subject data to meet quantity specifications of the end user's request (step 6). The resulting data items are displayed in a Trading Room screen view 32 as a view of the relevant market customized for the end user in response to his request.

FIGS. 6A-6D further illustrate the results of the Quantity Filter 33 in the context of a user viewable Trading Room. The information content represented therein is also identical to that transmitted from the Quantity Filter 33 back into the STMS for optimal order selection and execution discussed in FIG. 4. FIG. 6A illustrates the Trading Room view 32 displaying the full market for steel. Several users have multiple Bids and Asks at various prices and various quantities. All entries are considered separate items.

If the Quantity Filter 33 is activated and a quantity of “1” is chosen, a Trading Room View 32 of FIG. 6B will be seen. Here, each listing is filtered to show a true market for a single unit of steel.

FIG. 6C shows how the market for 2 units of steel would be displayed. Several customizations by the Commodity and Quantity Filters 34, 33 have occurred. On the Bid side, the Bids for 1 unit of steel from Nlh and Fertik have been combined to form a single Bid for 2 units of steel. The individual prices have been combined and the adjusted per-item price has been calculated and is displayed. Bwallis's Bid for 3 units of steel (in FIG. 6A) has been quantity filtered down to 2, Gkiley's 2 remain the same, and Gabriel's 4 has been quantity filtered down to 2 as well. The system 31 does not aggregate items between users unless it has to, since in general it is less desirable to purchase from 2 people than from 1.

In FIG. 6C, Nlh and Fertik have their items aggregated because a group of 2 cannot be formed any other way by Nlh or Fertik independently. It should be noted, however, that it would have been possible to group 2 of the 3 from Bwallis together (as is done) and then combine the remaining unit of steel with 1 from Gkiley. This is not done, of course, since in that case Gkiley's items are unnecessarily split. For consistency, the Quantity Filtered market for 3 items would appear as in FIG. 6D.

In its preferred embodiment, the Quantity Filter 33 is implemented as a Java program, written as filter module that operates on a backbone of the Java Messaging Service (JMS). The Quantity Filter 33 receives messages that contain a structured XML (eXtensible Markup Language) document that lists a set of orders, including price and quantity information. It uses one of two detailed processes to perform the optimization and aggregation of orders. The first is labeled the “dynamic” process, as it is based directly on dynamic programming techniques such as those used in genetic sequencing and other processes that endeavor to solve recursive O (2\hat{0}n) problems in O (n\hat{0}2) time. This process performs the following steps:

1. Create a hashtable from key (order index, quantity) to value (mincost) and a hashtable from same key to value (optimal number of items)

2. Begin computeCost (long orderI, long orderJ, long quantity) where orderI is the bottom range index to check, orderJ is the top range index to check, quantity is the desired quantity of Commodities

a. If orderI>orderJ return infinity

b. If (orderI, quantity) is already hashed, return its hashed value

c. Start=0(start looking with 0 items from each order)

d. For (int I=Start; ; I++) where I is the number of items from orderI to check in this iteration

i If I<2 or I>orderI.quantityAvailable break;

ii. NewQuantity=quantity-I

iii. if (newQuantity>0) restCost=computeCost(orderI+1, orderJ, (int)newQuantity); else restCost=0;

iv. See if the solution of this order+the rest of the orders is better than the previous solution of this order+the rest of the orders. If so, make a note of it.

v. cost=orderCost+restCost;

vi. if (cost<mincost) optimalNumltems=i; {mincost=cost;}

vii See if the recursion was able to find a better solution. If so, use it. If not, use the current solution. Insert it into the mincost hashtable.

e. Insert best solution found in iteration into optimalNumltems hashtable.

f. Return mincost.

3. End computeCost.

This algorithm has a second variation in the preferred embodiment, which utilizes a speed optimizing heuristic known as the “Greedy” optimization. Step 2c is modified in this variant to take as many of the Commodities in the order as are available rather than starting with 0 and trying all possible values. This optimization requires a presorted input set by quantity and then by price, but results in vastly reduced running time under most common usage. The preferred embodiment of the Quantity Filter 33 is not to be interpreted as a limitation, but is only one possible implementation of a dynamic programming based approach to optimal order aggregation within an electronic Bid/Ask marketplace for Commodities that is claimed herein.

Referring back to FIG. 2, the matching technology in the invention is known as the Symmetric Transaction Matching System (STMS) 35. This technology facilitates fast and automatic clearing of the market represented by the displayed Trading Room (view 32). It is unwise to assume that all market participants will want or be able to follow the minute-by-minute movements of the market at all times in the Trading Room. Furthermore, many participants will not be interested in interacting with the Marketplace directly and will instead prefer to use their in-house requisitioning or catalogue software to handle direct market activities. In that case, the STMS 35 maintains an efficient real-time market that automatically matches buyers Bids and seller's Asks without the need for an end user to accept an order. The system is flexible enough not only to match directly compatible Bids and Asks (a “natural match”) but allows buyers and sellers to define a range of acceptable prices and expiration times toward clearing trades. As such, the STMS 35 allows for even greater flexibility and liquidity than other systems.

Although price-time rules have been previously discussed, the rules may further include expiration of an order (sellers' or buyers' ) after a period of time as predefined by the respective user. In the case where the sellers' rule is to decrease the asking price to a best Bid after a certain period of time, then the invention system 31 simulates auctioning. A rules processing engine may be employed by the STMS 35 to increase a seller's asking price as a function of buyers' activity and time (e.g., decrease the seller's asking price where low buyer activity exists over a predefined period of time). Likewise, on the buyer's orders, the rules processing engine may increase the buyer's Bid price to the minimum seller's asking price where no match has been found after a buyer's predefined period of time.

Implementation of the preferred embodiment of the STMS 35 is then as follows: the STMS 35 responds as an event-driven system. Events are defined as changes in the rule or status of orders in the system 31. Rules changes are modifications of an order's properties by its owner. Status changes include indications to purchase or sell an order by a user, the set expiration of an order, or the cancellation of an order. Whenever an event occurs in the overall exchange, notification is sent to the STMS 35 and a comparison between the Bids and the Asks in that Trading Room is made. If any orders are matching in price, the STMS 35 automatically marks the matching Bids and Asks as completed, removes the order entries from the list of active Marketplace orders, updates the transaction history database 36 with information about the transaction, and sends notification to both of the counterparties that the transaction was completed. The comparison procedure is repeated until orders can no longer be matched, and the system 31 returns to the idle state and waits for the next event notification.

In the preferred embodiment, the STMS 35 employs the rules stored in the database 36 for the sellers' and buyers' orders involved in the current Trading Room. A task manager process executes the rules by tracking and calculating variables (elapsed time, quantitative level of buyers' activity, quantitative level of sellers' activity) and by arriving at functional results (e.g., after the seller's predefined period of time has passed, lowering the asking price; or after the buyer's predefined period of time has passed, increasing the Bid price). As soon as a match exists between a buyer's Bid and a seller's Ask in a Trading Room the STMS 35 completes the transaction. In this embodiment, the STMS 35 is implemented as an independent Java application that uses input order sets (Trading Room views 32) and outputs sets of matched orders and the successful quantities of orders matched. The input sets may have been processed by one or more filters already, including the Quantity Filter 33 and the Commodity Filter 34, as shown in FIG. 4.

With reference to FIG. 2, the Market Hunter 37 portion of the system 31 moves the Marketplace beyond the boundaries of the immediate online Trading Room. It works alongside the STMS 35 to facilitate a seamless online Marketplace by interfacing with previously static buy-side requisitioning systems and sell-side catalogs to import Bids and Asks into the current exchange. The displayed Bids and Asks are thus further updated by these same external systems and the STMS 35 is thus able to match and clear those orders (opening up the possibility for a completely automatic Marketplace that requires minimal interaction). In addition, if the system 31 detects a limited number of active buyer Bids or seller Asks in a particular Trading Room, the Market Hunter 37 searches the address book portion of the database 36 for appropriate participants (buyers and sellers). Users are indexed in the database by Class of Commodities most commonly dealt with, frequency of participation, seasonal preferences, etc. The results of the Market Hunter 37 search of the database 36 are a subset of users not currently participating in a given Trading Room. The Market Hunter 37 immediately contacts this subset of users (by email, facsimile, etc.) and automatically generates RFPs (Request For Proposals) and RFQs (Request For Quotes) in an attempt to draw dormant participants into a given Trading Room. User responses may then automatically be entered into the Trading Room and once again create a custom user specific Marketplace.

While this invention has been particularly shown and described with references to preferred embodiments thereof, it will be understood by those skilled in the art that various changes in form and details may be made therein without departing from the scope of the invention encompassed by the appended claims.

Although the foregoing description is in the context of the Internet, other pluralities of loosely coupled computers (intranets, local area networks, wide area networks, etc.) are suitable.

What is claimed is:

1. In a computer network, apparatus for supporting open market trading comprising:
a. a source of information providing
i. a plurality of Asks for certain products from different sellers;
ii. a plurality of Bids for a general product type from different buyers;
b. A means for receiving from a buyer or a seller an order to buy or sell a subject product, the product being of a subject Class; and
c. One or more filters coupled to the receiving means and the source of information, for parsing sets of Bids and Asks for a specific Class of products such that a customized screen view for the subject Class of product is displayed and enables desired trading on the same.

2. Apparatus as claimed in claim 1 wherein the filters process orders across different buyers or sellers as a function of quantity and price.

3. Apparatus as claimed in claim 1 wherein at least one filter enables the combination of Asks across different sellers to form an aggregate quantity and price of the subject product which fulfills a sum total of different buyers' orders.

4. Apparatus as claimed in claim 1 wherein at least one filter enables combining of different Bids across different buyers to form a sum total quantity that matches selling quantity of a seller's order.

5. Apparatus as claimed in claim 1 wherein the customized screen view is a Trading Room screen view displaying buyers' Bids and sellers' Asks for the subject Class of product.

6. Apparatus as claimed in claim 5 wherein the Trading Room screen view serves as the means for receiving Bids.

7. Apparatus as claimed in claim 1 further comprising a processor routine responsive to the filters for obtaining additional buyers or sellers for the subject orders by generating notifications targeted toward appropriate parties from existing, unfulfilled orders.

8. Apparatus as claimed in claim 1 wherein asking prices of a seller for a particular Ask include different prices as a function of time.

9. Apparatus as claimed in claim 1 wherein asking prices of a seller for a particular Ask include different prices as a function of trading activity for the product Class.

10. A method for carrying out Commodity transactions, comprising the computer implemented steps of:
a. Providing a plurality of Asks for certain products from different sellers;
b. Providing a plurality of Bids for a general product type from different buyers;
c. Receiving from a buyer or a seller an order to buy or sell a subject product; and
d. any combination of combining Bids as a function of quantity and price to fulfill a seller's order, and combining Asks as a function of quantity and price to fulfill a buyer's order.

11. A method as claimed in claim 10 wherein the step of combining Asks includes combining Asks from different sellers.

12. A method as claimed in claim 10 wherein the step of combining Bids includes combining Bids from different buyers.

13. A method as claimed in claim 10 further comprising the step of displaying to a user a subset of the Asks and Bids with attribute information from different buyers or sellers as a function of Commodity Classification attributes specified by the user.

14. A method as claimed in claim 10 further comprising the step of processing a subset of the Asks and Bids with attribute information from different buyers or sellers as a function of Commodity Classification attributes specified within an existing order.

15. A method as claimed in claim 13 wherein:
the step of displaying a subset includes parsing the plurality of Bids and Asks from different buyers or sellers according to preferences of quantity and price; and
the step of combining includes combining similar Bids or Asks across multiple different buyers or sellers, to form a sum total Bid or Ask for the subject product that matches quantity specified in the received order.

16. A method as claimed in claim 14 wherein:
the step of processing a subset includes parsing the plurality of Bids and Asks from different buyers or sellers according to preferences of quantity and price; and
the step of combining includes combining similar Bids or Asks across multiple different buyers or sellers, to form a sum total Bid or Ask for the subject product that matches quantity specified in the received order.

17. A method as claimed in claim 16 further comprising the steps of:
simulating an auction or reverse auction for an Ask or Bid respectively where the Ask or Bid specifies an expiration time and, optionally, a threshold price; and
expiring an Ask or Bid at the specified expiration time by triggering the steps of parsing and combining such that a best existing match for the expiring Ask or Bid is found within the threshold price.
